(19) United States
(12) Patent Application Publication
(10) Pub. No.: US 2002/0093952 A1
(43) Pub. Date: Jul. 18, 2002

(54) Method for managing circuits in a multistage cross connect

(76) Inventor: Rumi Sheryar Gonda, Boxborough, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/894,365

(22) Filed: Jun. 28, 2001

Related U.S. Application Data
(60) Provisional application No. 60/215,689, filed on Jun. 30, 2000.

(51) Int. Cl. H04L 12/50

(52) U.S. Cl. 370/369; 370/386

(57) ABSTRACT

To alleviate the problems associated with modifying switching software for each individual hardware components, a logical switch abstraction is provide that is separated from an underlying physical switch abstraction, the physical abstraction being dependent upon the underlying components used in the switch. The abstraction is a model of the connection paths and switching elements of the switch. By efficiently determining connections within the logical abstraction and mapping those connections in the physical abstraction, changes in underlying hardware has a minimal effect on switching software. That is, adding new hardware to the switch has minimal effect on how connections are determined through the logical abstraction. More particularly, when a hardware type is changed or added, only mapping information identifying relations between components in the logical and physical abstractions changes. Because the logical abstraction is independent of the hardware implementation, connections are more easily managed. Further, an efficient method of provisioning is provided wherein the amount of connection time is reduced.

### RELATED APPLICATIONS

This application claims the benefit under Title 35 U.S.C. §119(e) of co-pending U.S. Provisional Application Serial No. 60/215,689 filed Jun. 30, 2000, entitled “Method for Managing Circuits in a Multistage Cross connect” by Rumi S. Gonda, the contents of which are incorporated herein by reference.

### FIELD OF THE INVENTION

The field of the invention relates generally to network switching architecture, and more specifically, to managing circuits in a switching architecture.

### BACKGROUND OF THE INVENTION

As communication networks become more complex and the need for high performance networks rises, a tremendous burden is placed on networking devices to effectively and efficiently communicate data between computer systems. Communication between systems is facilitated in most communication networks by network communication systems referred to in the art as switches. A switch receives data from systems coupled to one or more ports of the switch and transfer the received data to systems coupled to one or more output ports of the switch. By connecting systems and other networks by one or more switches, larger networks may be constructed.

There are many different types of switches having different architectures that may be used in a communication network. A switch in the general sense is a device which receives signals defining data, and transmits these signals to other media, with or without modification. The switch may include, for example, hardware, software, or combination thereof which performs reception and transmission of signals between ports of the switch. Switches typically form connections between an input port to an output port of the switch through one or more switching elements. These connections may be real or virtual connections, hardware or software connections, or any other type of connection used to transfer data. For example, the switch may include one or more switching elements such as a crosspoint r×n switching element that connects r inputs to n outputs.

A crosspoint switching element, or crossbar matrix, is a common element used to implement a switch. The crosspoint element is typically coupled to one or more other crosspoint elements, the crosspoint elements collectively forming what is known in the art as a switch fabric, a switch fabric being defined generally as a construct coupling one or more input and output lines.

For example, a switch may include a crossbar matrix connecting r inputs and n outputs by r×n cross-points formed at the intersection of the inputs and outputs. The implementation of cross-points in a crossbar has progressed from electromechanical relays, electronic gates, controllable optical couplers, and other hardware used to couple signals between input and output lines.

A common method for constructing switch fabrics that are more economical with respect to using crosspoints is performed using a multistage switch fabric. A popular arrangement is a three-stage arrangement, which can be configured to produce many types of switches. Because multistage configurations are used, switch configurations may be realized with far-fewer crosspoints in the crossbar than that of a single or two-stage element. A switch architecture referred to in the art as a Clos switch architecture is commonly used to implement a switch. An example Clos network architecture is shown in FIG. 1.

The three-stage Clos switch architecture shown in FIG. 1 includes k pxm switch elements 101A-101B in a first stage, m kxk switch elements in a middle stage, and k mxp switch elements 101F-101G in a third stage, wherein the number of input and output connections is n=kp. One implementation of switches 101A-101G includes using crossbar switches discussed above for each of the switch elements 101A-101G. To connect an input port to an output port, a connection is mapped from a port on an ingress switch element such as element 101A through a second stage element such as element 101D, and the connection is mapped to the destination through a third stage switch element such as element 101G.

The general Clos architecture shown in FIG. 1 may be used to derive other switch architectures such as the well-known Benes switch fabric used in optical switching and other switching applications. For example, an optical switch may be constructed by multiple stages of 2×2 switching elements, configured in a Benes switch architecture. Clos and other types of switch architectures are more thoroughly discussed in the book entitled “Multiwavelength Optical Networks—A Layered Approach” by Thomas E. Kern, et al. Addison-Wesley Longman, Reading, Mass. (1999), incorporated herein by reference.

Connections made by switches allow the formation of circuits between a source and destination computer system. Circuits as is known in the art are communication paths over which data is transmitted. Circuits may be defined through one or more switches, may be real or virtual, or may be any type of data transfer path used for transferring data between a source and destination. Provisioning is a process performed by a switch for reserving resources within the switch, and setting up a data transfer path between an input port and output port. Provisioning activities may be performed among a number of switches to set up a data transfer path between a source and destination.

As the number of stages increases within a switch, it becomes more difficult to determine a communication path through the switch architecture. That is, for any given set of desired connections (any permutation of inputs connected to outputs), device settings of hardware within the switch are not determined easily because of the number of possible connections that may be mapped through the switch fabric. Although the components used to construct the switch may be simple, the control mechanism for provisioning circuits is generally complex.

In conventional switching systems, software that performs circuit connection is based upon the hardware implemented in the switch. More particularly, software developed for execution within a switch to manage connections is tailored specifically to the subsystems and hardware components that perform switching. When additional hardware is added to the switch, such as when a new interface hardware type is added, the software needs to be revised to support the new hardware type. Because the software is dependent on the types of hardware used, development and testing of software to support new hardware is not a trivial task. Further, due to the packaging and types of hardware components within subsystems of the switch, programming connections in the node between different subsystems is not straightforward.

### SUMMARY OF THE INVENTION

To alleviate the problems associated with modifying switching software for each individual hardware components, a logical switch abstraction is provide that is separated from an underlying physical switch abstraction, the physical abstraction being dependent upon the underlying components used in the switch. The abstraction is a model of the connection paths and switching elements of the switch. By efficiently determining connections within the logical abstraction and mapping those connections in the physical abstraction, changes in underlying hardware has a minimal effect on switching software. That is, adding new hardware to the switch has minimal effect on how connections are determined through the logical abstraction. More particularly, when a hardware type is changed or added, only mapping information identifying relations between components in the logical and physical abstractions changes. Because the logical abstraction is independent of the hardware implementation, connections are more easily managed. Further, an efficient method of provisioning is provided wherein the amount of connection time is reduced.

According to one aspect of the invention, a method is provided for determining a connection in a network system. The method comprises defining a logical abstraction having a plurality of switch stages, each stage having at least one port; defining a physical abstraction having an associated plurality of components wherein at least one component has a physical port; and mapping the at least one port in the logical abstraction to the physical port of the component associated with the physical abstraction. According to another embodiment of the invention, the method further comprises determining a logical path through the plurality of switch stages defined by the logical abstraction.

According to another embodiment of the invention, each of the plurality of connections between each stages are represented by a level of a logical representation, the logical representation holding state information indicating an availability of said connections, the plurality of switch stages having a plurality of connection between stages, and the method further comprises setting up a circuit between an ingress and egress port of the network system. According to another embodiment of the invention, the setting up operation comprises processing a request to establish the circuit; determining an egress port of a third switch stage of the plurality of switch stages in the logical abstraction; locating, within the logical representation, an available connection between the third switch stage and a second switch stage of the plurality of switch stages; and locating, within the logical representation, an available connection between the second stage and a first switch stage in which the ingress port resides.

According to another embodiment of the invention, if it is determined that an available connection does not exist between the ingress and egress ports, the method further comprises searching another second switch stage for an available connection.

According to another embodiment of the invention, the location operations include identifying a first found connection. According to another embodiment of the invention, the location operations include identifying a connection using a round robin search. According to another embodiment of the invention, the location operations include identifying a connection using a randomization process.

According to another embodiment of the invention, the logical abstraction includes logical switch elements having logical ports identified by a logical port number, and the mapping operation further comprises mapping a logical port number to the physical port of the component. According to another embodiment of the invention, the method further comprises mapping based on a combination of chassis, slot, port, wave, and channel. According to another embodiment of the invention, the logical abstraction is modeled as a generic Clos switch architecture. According to another embodiment of the invention, the physical abstraction is modeled as a hardware-specific Clos switch architecture. According to another embodiment of the invention, the logical representation is stored in at least one table in memory of the switch. According to another embodiment of the invention, the logical representation is a tree-like data structure stored in a memory associated with the switch.

According to another embodiment of the invention, the method further comprises determining whether an available link has sufficient resources. According to another embodiment of the invention, the setting up operation includes setting up a connection in a direction from the ingress port to the egress port. According to another embodiment of the invention, the setting up operation includes setting up a connection in a direction from the egress port to the ingress port. According to another embodiment of the invention, the plurality of switch stages includes at least three switch stages.

According to another aspect of the invention, a computer-readable medium is provided that, when executed in a network communication system, performs a method for determining a connection in a network system. The performed method comprises defining a logical abstraction having a plurality of switch stages, each stage having at least one port; defining a physical abstraction having an associated plurality of components wherein at least one component has a physical port; and mapping the at least one port in the logical abstraction to the physical port of the component associated with the physical abstraction. According to another embodiment of the invention, the method further comprises determining a logical path through the plurality of switch stages defined by the logical abstraction.

According to another embodiment of the invention, each of the plurality of connections between each stages are represented by a level of a logical representation, the logical representation holding state information indicating an availability of said connections, the plurality of switch stages having a plurality of connection between stages, and the method further comprises setting up a circuit between an ingress and egress port of the network system.

According to another embodiment of the invention, the setting up operation comprises processing a request to establish the circuit; determining an egress port of a first switch stage of the plurality of switch stages in the logical abstraction; locating, within the logical representation, an available connection between the first switch stage and a second switch stage of the plurality of switch stages; and locating, within the tree representation, an available connection between the second stage and a third switch stage in which the ingress port resides. According to another embodiment of the invention, if it is determined that an available connection does not exist between the ingress and egress ports, the method further comprises searching another second switch stage for an available connection. According to another embodiment of the invention, the location operations include identifying a first found connection. According to another embodiment of the invention, the location operations include identifying a connection using a round robin search. According to another embodiment of the invention, the location operations include identifying a connection using a randomization process.

According to another embodiment of the invention, the logical abstraction includes logical switch elements having logical ports identified by a logical port number, and the mapping operation further comprises mapping a logical port number to the physical port of the component.

According to another embodiment of the invention, the method further comprises mapping based on a combination of chassis, slot, port, wave, and channel.

According to another embodiment of the invention, the logical abstraction is modeled as a generic Clos switch architecture. According to another embodiment of the invention, the physical abstraction is modeled as a hardware-specific Clos switch architecture. According to another embodiment of the invention, the tree representation is stored in at least one table in memory of the switch. According to another embodiment of the invention, the method further comprises determining whether an available link has sufficient resources.

According to another embodiment of the invention, the setting up operation includes setting up a connection in a direction from the ingress port to the egress port. According to another embodiment of the invention, the setting up operation includes setting up a connection in a direction from the egress port to the ingress port. According to another embodiment of the invention, the plurality of switch stages includes at least three switch stages.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

The invention is pointed out with particularity in the appended claims. The above and further advantages of this invention may be better understood by referring to the following description when taken in conjunction with the accompanying drawings in which similar reference numbers indicate the same or similar elements.

In the drawings,

FIG. 1 shows a conventional Clos switch architecture;

FIG. 2 shows a conventional switching system in which one embodiment of the invention may be implemented;

FIG. 3 shows a diagram of a logical abstraction and corresponding mapping to a physical abstraction in a switch according to one embodiment of the invention;

FIG. 4 shows an example of circuit routing in a switch fabric according to one embodiment of the invention;

FIG. 5 shows a logical representation used to track connections in a switch according to one embodiment of the invention;

FIG. 6 shows a process for establishing a unicast connection in a switching architecture according to one embodiment of the invention;

FIG. 7 shows a process for establishing multicast connections in a switching architecture according to one embodiment of the invention;

FIG. 8 shows a switch architecture in which one embodiment of the invention may be implemented; and

FIG. 9 shows a software architecture that may be used to implement various embodiments of the invention.

### DETAILED DESCRIPTION

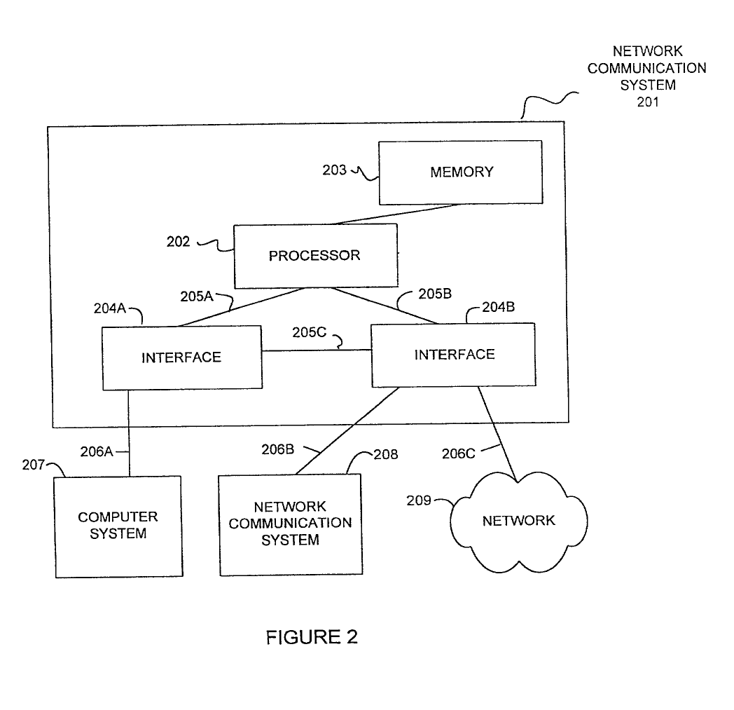

FIG. 2 shows a network communication system suitable for implementing various embodiments of the invention. More particularly, management of connections according to various embodiments of the invention may be performed in one or more components of a network communication system 201.

A typical network communication system 201 includes a processor 202 coupled to one or more interfaces 204A, 204B. Components of network communication system 201 may be coupled by one or more communication links 205A-205C which may be, for example, a bus, switch element as described above, or other type of communication link used to transmit and receive data among components of system 201. According to one embodiment of the invention, a processor managing circuits is implemented in a network communication system having at least three switching stages. For example, one stage may be located in each interface 204A, 205B, respectively, and a third stage may function as an interconnect between interfaces 204A, 204B. It should be appreciated that various aspects of the invention may be implemented on different network communication systems having different configurations.

Processor 202 may have an associated memory 203 for storing programs and data during operation of the network communication system 201. Processor 202 executes an operating system, and as known in the art, processor 202 executes programs written in one or more computer programming languages. According to one embodiment of the invention, management of circuits may be performed by one or more programs executed by processor 202. Interfaces 204A, 204B may themselves have processors that execute programs, and functions involving management of connections may also be performed by interfaces 204A, 204B. In general, various aspects of connection management may be centralized or distributed among various components of network communication system 201.

In such a network communication system 201, processor 202 may be a commercially-available networking processor such as an Intel i960 or x86 processor, Motorola 68XXX processor, Motorola PowerPC processor, or any other processor suitable for network communication applications. The processor also may be a commercially-available general-purpose processor such as an Intel Pentium-type processor, AMD Athlon, AMD Duron, Sun UltraSPARC, Hewlett-Packard PA-RISC processors, or any other type of processor. Many other processors are available from a variety of manufacturers. Such a processor usually executes an operating system, of which many are available, and the invention is not limited to any particular implementation. An operating system that may be used may include the Linux, VxWorks, Unix, or other type of operating system. The Linux operating system is available from Red Hat Software, Durham, N.C., and is also freely available on the Internet. The VxWorks operating system is available from the WindRiver Software Corporation, Alameda, Calif. The Unix operating system is available in a variety of forms and is available from a variety of vendors.

Various embodiments of the invention may be implemented in software or specially-programmed, special-purpose hardware. For example, according to one embodiment of the invention, connection management functions may be performed by a software program that manages switching hardware. For example, various embodiments of the present invention may be programmed using an object-oriented programming language, such as SmallTalk, Java or C++, as is known in the art. Other programming languages are available. Alternatively, functional programming may be used. It should also be appreciated that the invention is not limited to any particular computer system platform, processor, operating system, or network. It should also be apparent to those skilled in the art that the present invention is not limited to a specific programming language or computer system and that other appropriate programming languages and other appropriate computer systems could also be used.

System 201 includes one or more network interfaces 204A-204B which receive and transmit data. Interfaces 204A, 204B may also include their own processors and memory for code and data storage. Interfaces 204A, 204B may have one or more connections to other interfaces or processors within system 201 or memory 203. Interfaces 204A, 204B typically provide functions for receiving and transmitting data over one or more communication links 206A-206C. For example, links 206A-206C may be any communication medium that can be used to transmit or receive data. For example, links 206A-206C may be copper, fiber, or other communication medium. Network communication system 201 communicates over communication channels 206A-206C to one or more end systems 207, other network communication systems 208, or any other type of communication network 209.

End system 207 may be, for example, a general-purpose computer system as known in the art. A general-purpose computer system (not shown) may include a processor connected to one or more storage devices, such as a disk drive. Devices of a general-purpose computer may be coupled by a communication device such as a bus. A general-purpose computer system also generally includes one or more output devices, such as a monitor or graphic display, or printing device. Further, the general purpose computer system typically includes a memory for storing programs and data during operation of the computer system. In addition, the computer system may contain one or more communication devices that connect end system 207 to a communication network and allow system 207 to communicate information. This communication device may be, for example, a network interface controller that communicates using a network communication protocol.

Network 209 may be, for example, a communication medium or a combination of media and active network devices that receive and transmit information to system 201. Network 209 may include, for example, a wave division multiplexed (WDM), SONET, ATM, Frame Relay, DSL or other type of wide area network (WAN) protocol types, and/or Ethernet, Gigabit Ethernet, FDDI or other local area network (LAN) protocols. It should be understood that network 209 may include any type and number and combination of networks, and the invention is not limited to any particular network implementation.

To alleviate the problems associated with modifying switching software for each individual hardware components, connection management software is provided which provides a logical abstraction separate from an underlying physical abstraction, the physical abstraction being dependent upon the underlying components used. In particular, the switch fabric of a switch is represented by a logical abstraction and a physical abstraction to make it easier to manage. In the logical plane, mathematical models may be used to represent the cross connect. Because hardware of the switch fabric is not necessarily linearly mapped to a clean mathematical model of a switch, this decoupling between the logical and physical plane is of great benefit. The hardware is accessed by maintaining a mapping between the logical plane and the physical plane. This mapping allows the connection management code to be independent of the physical hardware and hence can be used with different hardware chipsets and interconnect layouts, or any type of connection such as digital or optical interconnections. This multilevel architecture allows for separation of management of the logical and physical resources such that components of a switch can be distributed over several modules or subsystems within the switch, allowing for each subsystem to determine what setup and management has to be performed at the subsystem level. This architecture allows for a scaleable distributed or centralized implementation.

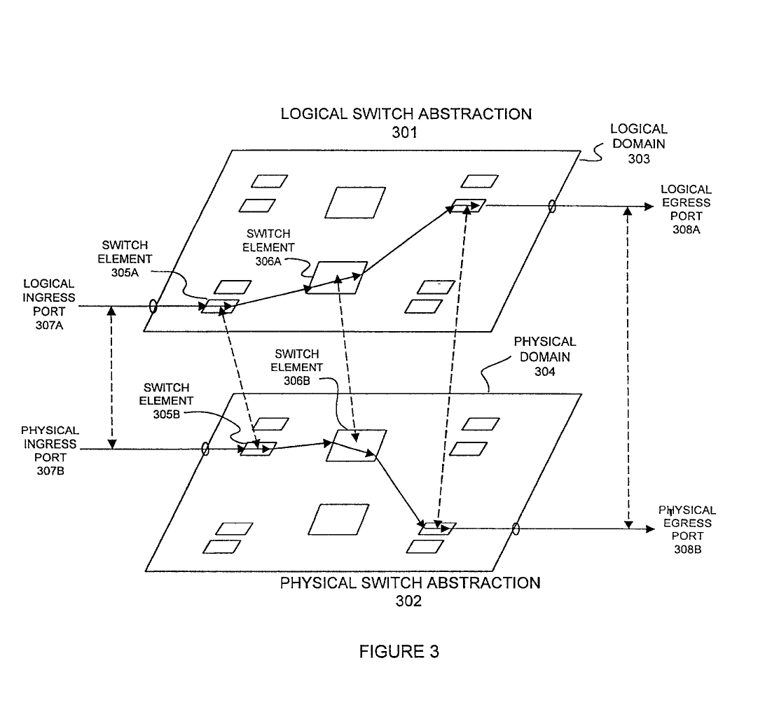

FIG. 3 shows a diagram of a logical abstraction and corresponding mapping to a physical abstraction in a switch according to one embodiment of the invention. More particularly, a switch establishes connections within a logical switch abstraction 301 which defines a number of logical switch elements 305A, 306A connected by links. Connections are determined in a logical domain 303 between a logical ingress port 307A through one or more switch elements 305A, 306A to a logical egress port 308A. The determined connections are then mapped to entities within a physical switch abstraction 302 which defines, in a physical domain 304, a number of switch elements 305B, 306B and their links. More particularly, logical ports and links are mapped to physical ports and links, respectively, in the physical domain 304. Further, switch elements within the logical domain 303 are mapped to switch elements in the physical domain 304. In particular, logical egress port 308A is mapped to a physical egress 308B, logical ingress port 307A is mapped to physical ingress port 307B, and logical switch elements 305A, 306A are mapped to physical switch elements 305B, 306B, respectively. Because connections are managed in this manner, changes within the physical domain 304 do not necessarily have an effect on the switch architecture in logical domain 303, and therefore hardware changes have minimal effect on software that performs logical connection management.

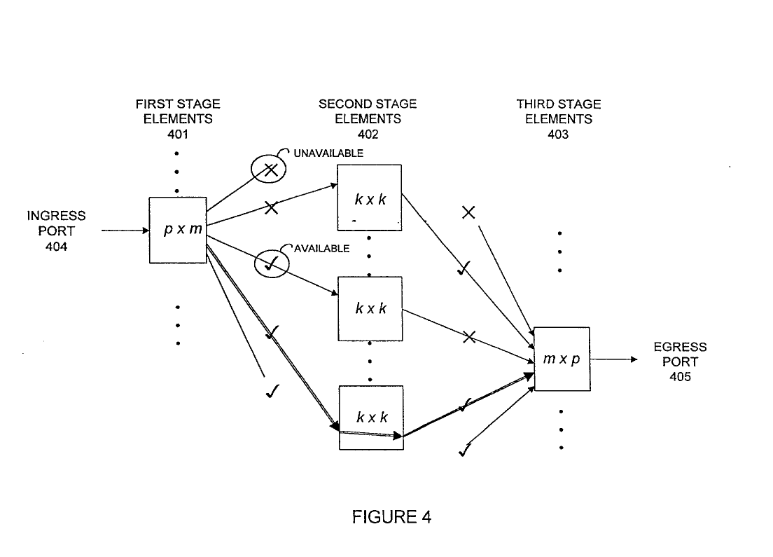

FIG. 4 shows an example of circuit routing in a switch fabric (or cross connect) according to one embodiment of the invention. More particularly, a switch fabric may include one or more first stage switching elements 401 followed by one or more second stage elements 402. Connections are mapped from an ingress port 404 through one of a plurality of first stage elements 401 to one or more second stage elements 402. A connection is then mapped from one or more second stage elements 402 to a third stage element 403 and onto an egress port 405. Switching elements may switch information digitally, optically, or any other manner, and the invention is not limited to any particular implementation. Although only three stages of switching elements are shown, it should be appreciated that any number of stages may be used.

According to one embodiment of the invention, a connection management system determines a first found connection within the switch fabric. That is, the connection management system may begin searching from an arbitrary point within the switch fabric, and consecutively evaluate whether a link is available. For example, a link may be considered available if the link is unused, meets particular bandwidth requirements, and/or other desired parameters. The connection management system may search for available links among a number of switch elements using other search methods, including random searches, round robin search, or others. For example, one algorithm selects switch elements in a round robin manner so that connections are balanced over different switch elements in a particular stage. Further, a randomization may be performed whereby circuits are randomly distributed among elements of a particular stage. By distributing circuits randomly among switching elements of a particular stage, loss of any one switching element will not adversely affect all circuits.

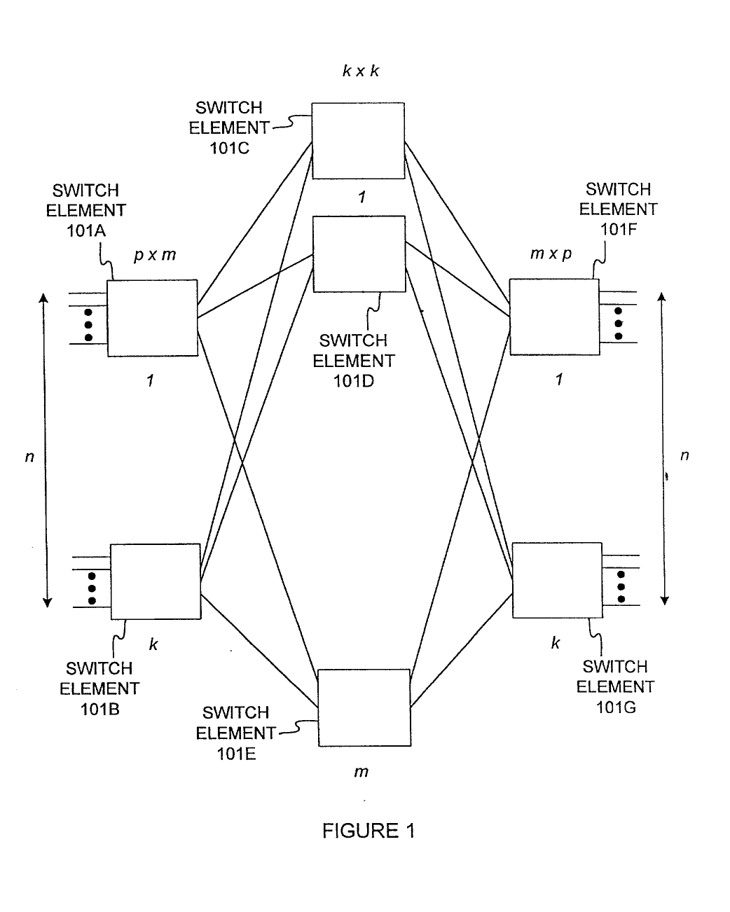

The cross connect hardware may be based on three stage Clos switch architecture as discussed above with reference to FIG. 1 because of its non-blocking attributes. More particularly, a Clos switch architecture is preferred over many other switch architecture as the architecture is non-blocking and requires the minimum number of switch elements. It should be understood that other switch architectures could be used and the invention should not be limited to the Clos switch architecture. An abstract mathematical model described in the logical plane that can be used to represent the switch in the logical level would be, for example, a Clos switch model. Each switch stage includes one or more switch elements that are connected to each other via links. Ports and links of the switch elements 401-403 are switch resources that need to be managed by a connection manager. The links between the stages may be represented, for example, in a storage area such as an array or table in memory of the switch, and the connection manager may manage the creation of connection by accessing state information stored in the storage area.

A mapping may then be performed between elements in the logical plane to elements in the physical plane. This mapping may be performed, for example, by representing the hardware in one or more table driven data structures. Based on the hardware type, an appropriate table is instantiated in memory of the switch and is used for managing connections created during switching hardware operations. The physical hardware may also be abstracted using a logical numbering scheme to identify switch resources, and this scheme may be used to setup the hardware using specific device drivers associated with specific hardware components. This additional abstraction in the physical plane allows for the physical model to also support multiple hardware vendors' chipsets with ease.

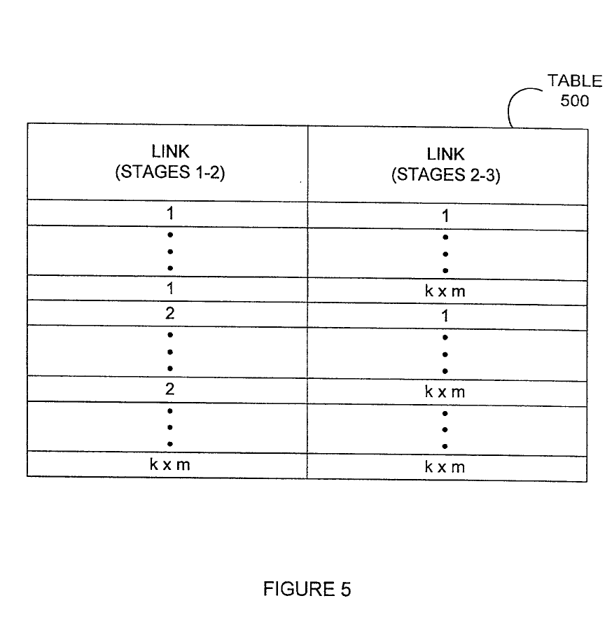

FIG. 5 shows a logical representation that may be used to track connections in a switch according to one embodiment of the invention. For example, a logical representation that may be used to track connections may include a table or other data structure used to store connection state information. Table 500 shown in FIG. 5 tracks the availability of links between switch stages. More particularly, table 500 tracks the availability of links between a first switch located in a first stage and a second switch located in a second stage. Table 500 may include a state indication, such as a bit, that indicates whether a link is available. If a link is available, a circuit may be established over second and third stages corresponding to a particular intermediate switch element, and table 500 may include state information for the availability of these second to third stage links. Therefore, the connection manager may search, in a recursive fashion, whether there are available links between each of the stages to make a connection between an ingress and egress port. Information stored in table 500 may also track other information regarding the links including resource information or other information used to evaluate whether a connection is available. Although a single table 500 is shown, it is shown by way of example only and it should be appreciated that connection availability information may be stored in one or more data structures located in memory of one or more switch components. For example, when more than a three stage switch is used or multiple paths exist between switch stages, the logical representation may be, for example, a tree-like data structure wherein branches represent possible paths that may be mapped through the cross connect. Other data structures may be used to represent connection states, and the invention is not limited to any particular implementation.

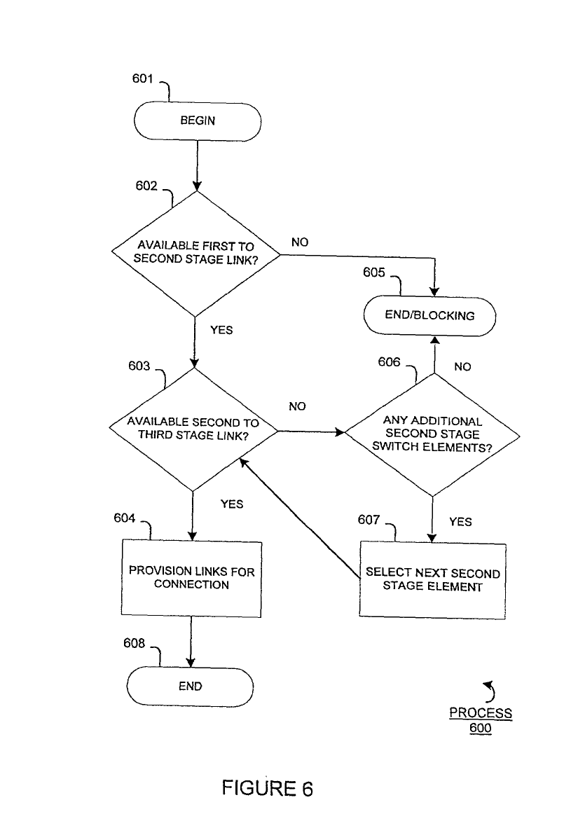

FIG. 6 shows a process 600 for determining a unicast connection between a source and destination. At step 601, process 600 begins. At step 602, it is determined whether there is an available link between the first and second stages of the cross connect. This determination may be made, for example, by inspecting a table such as table 500 described above. If there is no available link between first and second stage switch elements, the switch fabric is blocking, and the process ends at block 605. If there is an available first or second stage links, it is determined whether there is an available second to third stage link at block 603. If there is an available second to third stage link from the second stage switch element determined by the link identified at step 602, it is determined whether there are any additional second stage switch elements at step 606. If there are no additional second stage switch elements through which a connection may be mapped to a third stage, the cross connect is blocking and process 600 ends at step 605. If there is an additional second stage switch element, another second stage switch element is selected at 607, and its links are evaluated at step 603. If, for the current second stage element, there is an available second to third stage link, the first to second stage and second to third stage links are provisioned to establish a connection between the first and third stages at step 604. At block 608, process 600 ends.

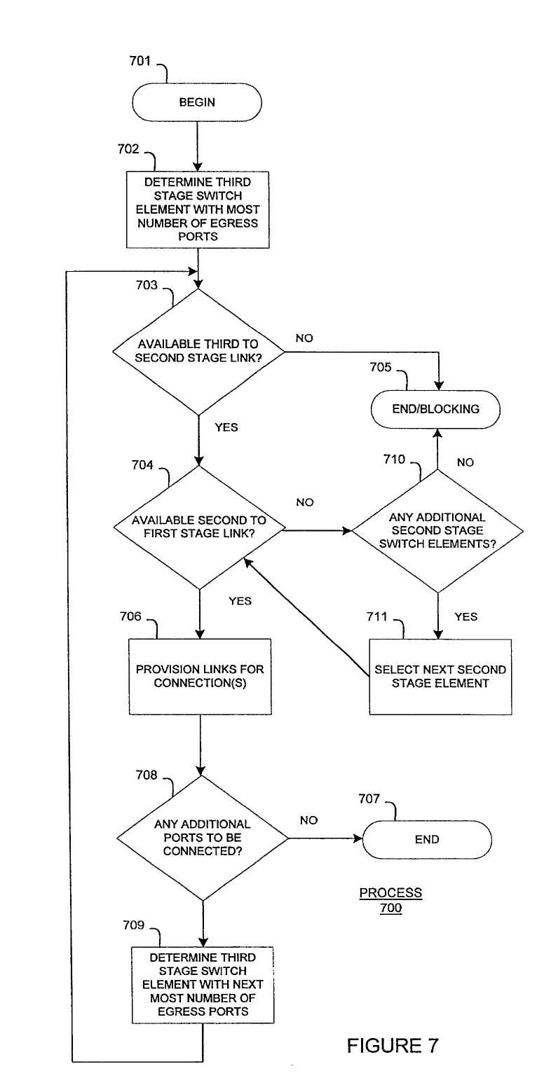

FIG. 7 shows a process for setting up multicast connections between one or more computer systems and another computer system coupled to at least one port of a switch. At block 701, process 700 begins. At block 702, a third stage switch element is determined which has the most number of egress ports which need to be connected to an ingress port. For example, a multicast source may be coupled to an ingress port, and data transmitted by the multicast source is transmitted to more than one egress port. At block 703, it is determined whether there is an available third to second stage link from the identified third stage switch element to any second stage switch element. If not, the switch is blocking and process 700 ends at block 705. If there is an available link from the second stage to the first stage, it is determined whether there is an available second to first stage link at block 704. If not, the switch is considered blocking, and process 700 ends at block 705. If there is an available connection, links determined in blocks 703 and 704 are provisioned to establish a connection between one or more egress ports of the third stage switch element and the ingress port having the multicast source. At block 707, it is determined whether there is another third stage switch element with a next highest number of egress ports that need to be connected to the multicast source. At block 708, it is determined whether there are additional ports to be connected, if not, process 700 ends at block 707. If so, additional third to second stage and second stage to first stage links are determined at blocks 703 and 704. Process 700 may be performed in an iterative manner until all egress ports attempting to connect to the multicast source are connected.

When a request to connect logical ports is performed, data structures representing the logical switch model are used to locate a link that connects an ingress port to a second stage switch element. It is then determined if it is possible to connect the second stage switch element with a link to a third stage element upon which the destination may be reached. This determination may be performed by searching an array representing the available set of links between each stage. For efficiency, a binary array may be used to store status information indicating the availability of individual links. For example, a switching algorithm may find the first available set of links that will allow the ingress port to be connected to the egress port.

Higher layers of the hardware abstraction provide physical ingress port and egress port coordinates to a mapping function. To jump from the physical abstraction to logical abstraction, a mapping is provided that allows indexing from a physical port coordinate to a logical port number in the logical abstraction.

To efficiently setup circuits both unidirectional and bidirectional in a multistage switch, resources of the switch need to be efficiently managed. In a multistage switch, connections are generally allocated such that the multistage switch is a non-blocking switch. That is, the switch is configured such that is a connection can be mapped between any ingress to egress port without being “blocked.” A method is needed by which a switch can locate the best route/path available in the multistage switch. This method may be used to setup, for example, unicast or multicast type circuits.

Cross Connect Manager (CCM)

A Cross Connect Manager (CCM) is provided which is responsible for providing a circuit route/path through the switch fabric, and the CCM manages all the resources of the switch. An upper functional layer of the switch such as signaling or routing may request for the creation of a unicast circuit of appropriate bandwidth and traffic descriptors to be setup between two ports on the switch fabric. In response, the CCM determines a circuit routing through the switch fabric that meets the requirements of the upper functional layer. The circuits can be unidirectional or bidirectional circuit. That is, with each connection established in a forward direction, there may be a corresponding connection established in an opposite direction.

When a request is made to setup a local circuit between two ports, the CCM indexes into the physical port to logical port mapping and finds the logical port number to use in the logical plane. The CCM determines, from the egress side, the first link that is available between the second stage and third stage by walking down a binary array, which indicates the availability of the links. Once the CCM has located an available link, then the CCM indexes into a link mapping between the first and second stage elements by directly starting at the location in the link available map table which coordinates to the links located on the element the ingress port is. If the CCM fails to find a link on the first stage element then the CCM attempts to locate another second stage to third stage element and retries the above process until a link is located.

Once a route/path has been found in the logical abstraction, the physical plane elements to be used for setting up the client are determined via the physical plane mappings. In the physical abstraction, the CCM locates the physical chassis number, slot number, port number, element number and link number to be used, and uses that identification information to setup the actual hardware using the appropriate chipsets device driver(s). For bidirectional circuits, the two endpoints of the connection are reversed and the same algorithm can be used with a reverse allocation table being used to verify availability of links.

A link searching algorithm does not depend on the way the links between elements are connected in the logical abstraction or the physical abstraction. One logical model could be setup such that all links from one switch element is assigned to a specific switch element of another stage. Also, for failure protection, the CCM could assign each link in the element of one stage to a different element of the following stage. The implementation can also be such that each of the abstractions can be centralized or distributed over several processors and/or systems.

The CCM may be implemented as software that executes in one or more processors of the switch, as hardware, or a combination thereof. The CCM may also function in a centralized or distributed manner. Other aspects of a CCM according to various embodiments of the invention are described in the U.S. Patent Application entitled Method For Restoring And Recovering Circuits In A Distributed Multistage Cross Connect, filed Jun. 28, 2001 by R. Gonda, Attorney Docket No. S1415/7008, incorporated herein in its entirety.

Hardware Architecture

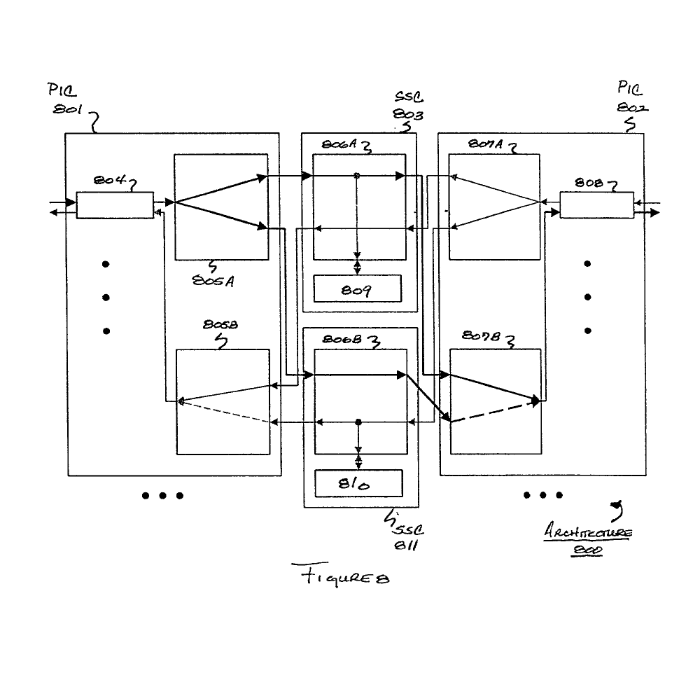

FIG. 8 shows a switch hardware architecture in which one embodiment of the invention may be implemented. Switch architecture 800 includes one or more Port Interface Cards (PICs) which serve as interfaces (such as interfaces 204A, 204B of FIG. 2) of a network communication system 201. Architecture 800 also includes one or more Space Switch Cards (SSCs) 803, 811 that perform intermediate switching between PIC cards. As discussed above, the cross connect hardware may be implemented by a three staged Clos switch architecture. The first and third stages may be implemented by hardware located on one or more Port Interface Cards (PICs) 801, 802. The second stage is implemented by hardware on one or more Switch Space Cards (SSCs) 803, 811.

PICs 801, 802 may include ports implemented by framer modules 804, 808 that perform framing of data to be transmitted to one or more ports using a communication protocol such as SONET/SDH. An output of each framer module 804, 808 is connected to a corresponding cross connect module 805A, 807A. Similarly, PICs 801, 802 may include cross connect modules 805B, 807B each connected to an output of SSCs 803, 811. Outputs of cross connect modules 805A, 807A are in turn connected to inputs of SSCs 803, 811. Both the framer modules 804, 808 and cross connect modules 805A-B, 807A-B may be located on a respective PIC card, but this is not necessary. The SSCs 803, 811 each have respective cross connect modules 806A, 806B through which cross connect modules 805A-B, 807A-B are coupled. SSCs 803, 811 each include a respective monitoring module to perform monitoring functions. According to one embodiment of the invention, the cross connect modules 805A-B, 807A-B located on the PIC cards 801, 802 have sufficient number of output ports to support redundancy. Redundant SSC cards may be provided that are used to provide redundancy for the second/middle stage cross connect.

According to one embodiment of the invention, framing modules 804, 808 are hardware chips such as framing chips available from a variety of vendors, including the Vitesse Semiconductor Corporation of Camarillo, Calif. If the network is a SONET/SDH network, framing modules 804, 808 may be SONET/SDH framing chips such as Missouri framing chips available from Vitesse. Similarly, cross connect modules 805A-805B, 807A-807B may be hardware chips such as crosspoint switches available from Vittesse. For example, 34×34 crosspoint switch chips may be used. Cross connect modules 806A-B may also be, for example, as crosspoint switches available from Vittesse. Modules 809, 810 may be, for example, SONET/SDH Operations, 30 Administration, Maintenance, and Provisioning (OAM&P) chips used to monitor SONET/SDH signals and provide section and line data. Modules 809, 810 may also be chips manufactured by Vitesse. Other chips from a variety of manufacturers may be used. It should be appreciated that the invention is not limited to any particular manufacturers product or any particular product implementation. Rather, it should be understood that other hardware or software may be used.

For redundancy, the cross connects input port is dual cast to a redundant output port for a cross connect module of the PIC card. The cross connect module of the redundant SMC card is programmed to pass the redundant cross connect output from the ingress PIC to through the redundant SSC cross connect on to the input of the egress PIC card. That is, data is transmitted over dual paths for redundancy purposes for both directions. Upon detection of error conditions the egress PIC cards cross connect is switched to the redundant input port.

Software Architecture

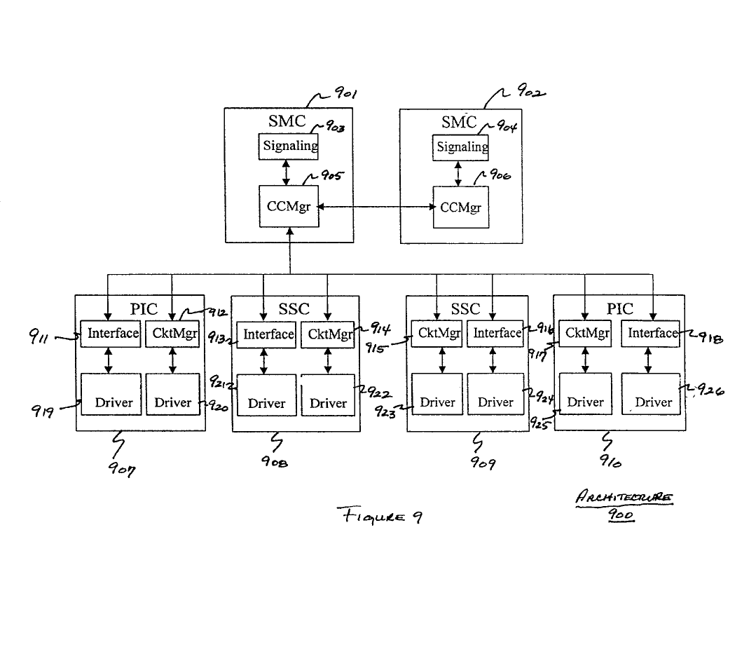

FIG. 9 shows one embodiment of a software architecture 900 that may be used in conjunction with the hardware architecture 800 shown in FIG. 8. As discussed above, the connection manager may be implemented as software which manages connections performed in hardware. More particularly, a Cross Connect Manager (CCM) software component manages the cross connect hardware. According to one embodiment of the invention, the Cross Connect Manager is an object-oriented software object (hereinafter referred to as a “CCMgr object”) that may be instantiated in memory of a Switch Management Controller (SMC) card. An SMC card is responsible for hosting switch and connection management functions that control and configure the cross connect. The CCMgr object coordinates the configuration of the cross connect hardware by communicating with objects located on the other interface (PICs 907, 910) and switching cards (SSCs 908, 909). Objects may communicate using a variety of methods, including well-known socket communication. Each cross connect stage in both the PICs 907, 910 and SSCs 908, 909 may be represented by Circuit Manager (CktMgr) objects 912, 914, 916, 918 that reside in memory of a corresponding stage card.

Additionally, there are Interface objects 911, 913, 915, 917 instantiated in memory of the SSC and PIC cards. Interface objects 911, 913, 915, 918 are responsible for all the protocol support (such as SONET/SDH), provide error monitoring and control functions, and are used to represent the interfaces of the modules. More particularly, physical ports of the PICs 907, 910 are each represented by Interface objects 911, 918. The Monitor port on the SSCs 908, 909 is represented by Interface objects 913, 915.

On an SMC 901,902, a Signaling object 903, 904 requests the Cross Connect Manager (CCMgr) object 905, 906 to connect two ports together, the two ports typically being an ingress and egress port of the switch. CCMgr 905 then sends requests to the Circuit Manager (CktMgr) objects 912, 914, 916, 918 on corresponding PICs 907, 910 and SSCs 908, 909 to set up the connection. At the PICs, each cross connect is represented by Circuit Manager (CktMgr) objects 912, 914, 916, 918. The CktMgr objects 912, 914, 916, 918 manage the connection/circuit table for that cross connect/switch stage. Similarly, at the SSCs 908, 909, each cross connect is represented by a Circuit Manager (CkttMgr) object 914, 916. The CktMgr object 914, 916 manages the connection/circuit table for that cross connect/switch stage. According to one embodiment of the invention, ingress and egress ports and stage element ports/links are addressed by their chassis (c) number, slot (s) number, port (p) number, conduit/wavelength (w) number, and channel (ch) number.

Port Mapping

The ingress ports, egress ports, and stage element ports/links generally do not have one to one mappings (nonlinear) because of hardware and mechanical layout complexities. Therefore, mappings may be maintained in one or more tables that indicate this nonlinearity. These tables may be different for different switch capacity/size configurations. Because interface ports may be bidirectional (ports both transmit and receive data), there may be twice the maximum number of interface port entries represented by these tables. The following example tables may be used in accordance with one embodiment of the invention to store mapping information:

1. ccmlngressPortMap[port] entry may have the following fields:

1. chassis on which the port is located

2. slot in chassis where the port is located

3. physical port on slot

4. conduit/wavelength in port

5. channel in conduit/wavelength

2. cktFirstStagePortMap[ingress port] entry may have the following fields:

1. element on the card

2. address connected to in first stage element

3. ccmFirstStageElementMap[element] entry may have the following fields:

1. chassis on which the element is located

2. slot in chassis where the element is located

4. cktSecondFromFirstStageLinkMap[first stage link] entry may have the following fields:

1. element on the card

2. address connected to in second stage element

5. ccmSecondStageElementMap[element] entry may have the following fields:

5. chassis on which the element is located

6. slot in chassis where the element is located

6. cktSecondFromThirdStageLinkMap[third stage link] entry may have the following fields:

1. element on the card

2. address connected to in second stage element

7. ccmThirdStageElementMap[element] entry may have the following fields:

3. chassis on which the element is located

4. slot in chassis where the element is located

8. cktThirdStagePortMap[egress port] entry may have the following fields:

1. element on the card

2. address connected to in third stage element

9. ccmEgressPortMap[port] entry may have the following fields:

1. chassis on which the port is located

2. slot in chassis where the port is located

3. physical port on slot

4. conduit/wavelength in port

5. channel in conduit/wavelength

Objects

The following is a description of various objects that may be used in one object-oriented software architecture according to one embodiment of the invention. It should be appreciated that any other type of software relations may be used, and that this implementation is merely an example, and should not be considered limiting.

Cross Connect Manager

The Cross Connect Manager (CCMgr) is logically be segmented into two distinct abstraction layers. The upper half is a generic Clos (L×K:N×N:K:L) switch architecture abstraction. The lower half is the actual hardware representation and mapping of any hardware to the general Clos switch architecture. Cross connect circuit routing can be performed independent of the hardware layout. Ports and links are then mapped on to the actual hardware layout and the switch is configured accordingly. In the future, if the physical architecture changes, only the lower layer entities need to be remapped to the upper layer entities.

Currently configured circuits are maintained in a Cross Connect table (ccmTable[cid]) indexed into by a circuit identifier (cid). Cids are allocated and maintained by the Circuit Identifier Manager (CIDMgr) object. This object is described in following sub-section. The ccmTable is a pointer of arrays for the maximum number of circuits supported. Each ccmTable entry is allocated and the pointer is stored in the corresponding ccmTable entry.

A class API may be provided that includes the following public and private member functions:

1. CCMgr(size, type): The constructor allocates memory for the ccmTable from heap for specified size. Based on the cross connect type, the constructor creates and initializes pointers so that the cross connect can be configured appropriately. If there is a failure to allocate memory, the object assumes a panic state.

2. ˜CCMgr( ): The destructor frees memory allocated for the CCM table from the heap, and clears the pointer to the table.

3. addEntry(cid, flags, ingressPort, egressport): This function creates a cross connect entry indexed in to the next available cid, and the entry is marked active. Default flags (0) indicates that the connection is bidirectional, protected, and a unicast entry. The function passes the allocated cid. In case of errors, the function returns an error status.

4. removeEntry(cid): This function removes the cross connect entry for the specified cid, and marks the entry inactive. In case of errors, the function returns an error status.

5. addEntryMC(cid, number, egressPortsMC): This function creates a unidirectional multicast circuit entry at cid index. The number of multicast egress ports being passed is specified for the function. One or more egress ports can be requested at the same invocation. If there is an error adding one or more egress ports, an error status is returned. Adding a multicast circuit for an inactive circuit results in an error.

6. removeEntryMC(cid, number, egressPortsMC): This function removes the specified multicast egress ports from the multicast circuit entry at cid. The number of multicast egress ports being passed is specified for the function. One or more egress ports can be requested at the same invocation. If there is an error removing one or more egress ports and error status is returned. Removing a multicast circuit for an inactive circuit results in an error.

7. getRoute(cid): This function creates a route between the ports specified in the circuit entry. The circuit entry can be unidirectional/bidirectional, unicast/multicast, protected/unprotected. This function creates a base circuit. In case of error, the function returns an appropriate error status.

8. getRouteMC(cid, egressport): This function creates a route between the base circuit and egress port. In case of errors, the function returns appropriate error status.

9. getRouteBD(cid): This function creates a bidirectional route for an unidirectional base circuit. In case of errors, the function returns appropriate error status.

10. getRouteP(cid): This function creates a protect route for an unprotected base circuit. In case of errors, the function returns an appropriate error status.

11. setFlags(cid, flags): This function sets flags relating to a particular cid. If the cid is invalid, the function returns an error status.

12. getFlags(cid, flags): This function passes back the flags. If the cid is invalid, the function returns an error status.

13. isActive(cid, status): This function passes back active status of the circuit entry. If the cid is invalid, the function returns an error status.

14. setBandwidth(cid, bandwidth): This function sets the physical bandwidth. If the cid is invalid, the function returns an error status.

15. getBandwidth(cid, bandwidth): This function passes back the physical bandwidth. If the cid is invalid, the function returns an error status.

16. setAvailable(cid, bandwidth): This function sets the available bandwidth. If the cid is invalid, the function returns an error status.

17. getAvailable(cid, bandwidth): This function passes back the available bandwidth. If the cid is invalid, the function returns an error status.

18. setTD(cid, td): This function sets the Traffic Descriptor. If the cid is invalid, the function returns an error status.

19. getTD(cid, td): This function passes back the Traffic Descriptor. If the cid is invalid, the function returns an error status.

20. getlngressport(cid, port): This function passes back the ingress port for the cid. If the circuit is inactive the function returns an error status. If the cid is invalid, the function returns an error status.

21. getEgressPort(cid, port): This function passes back the egress port for the cid. If the circuit is inactive the function returns an error status. If the cid is invalid, the function returns an error status.

22. getLink(cid, stage, link): This function passes back the current active link for the cid and stage. If the circuit is inactive the function returns an error status. If the cid is invalid, the function returns an error status.

23. getLinkW(cid, stage, link): This function passes back the working link for the cid and stage. If the circuit is inactive the function returns an error status. If the cid is invalid, the function returns an error status.

24. getLinkP(cid, stage, link): This function passes back the protect link for the cid and stage. If the circuit is inactive the function returns an error status. If the cid is invalid, the function returns an error status.

25. getCCMEntry(cid, entry): This function passes back the cross connect entry for the cid. If the circuit is inactive the function returns an error status. If the cid is invalid, the function returns an error status.

It should be appreciated that other functions may be used, and that the invention is not limited to any of the particular functions described above.

The following describes example ccmCircuitTable[cid] entry fields according to one embodiment of the invention:

1. ingress port

2. egress port

3. flags (active, uni/bidirectional, protected/redundant, multicast)

4. bandwidth

5. first stage element to second stage element working link

6. first stage element to second stage element protect link

7. second stage element to second stage element link

typedef uint32 chassis_t;
typedef uint32 slot_t;
typedef uint32 port_t;
typedef uint32 wave_t;
typedef uint32 chan_t;
typedef uint32 bandwidth_t;
typedef uint32 element_t;
typedef uint32 link_t;
typedef uint32 stage_t;
typedef uint32 td_t;
// Cross Connect Port Entry
typedef struct {

chassis_t chassis;
slot_t slot;
port_t port;
wave_t wave;
chan_t chan;

} ccmPortEntry_t;
// Cross Connect Link Entry
typedef struct {

chassis_t chassis;
slot_t slot;

} ccmLinkEntry_t;
enum ccm_FLAGS {

ccm_ACTIVE = (1<<0);
ccm_UNIDIRECTIONAL = (1<<1);
ccm_UNPROTECTED = (1<<2);
ccm_MULTICAST = (1<<3);
ccm_ALGORITHM = ((1<<5)|(1<<4));
ccm_ALGORITHM_FIRST = ((0<<5)|(0<<4));
ccm_ALGORITHM_BALANCED = ((0<<5)|(1<<4));
ccm_ALGORITHM_RESERVED = ((1<<5)|(0<<4));
ccm_ALGORITHM_RESERVED = ((1<<5)|(1<<4));

};
// Cross Connect Entry
typedef struct {

uint32 flags;
bandwidth_t bandwidth;
bandwidth_t available;
port_t ingressPort;
port_t egressPort;
link_t firstLink;
link_t firstLinkW;
link_t firstLinkP
link_t secondLink;
link_t secondLinkW;
link_t secondLinkP;
td_t *td;

} ccmEntry_t;
// Cross Connect Statistics
typedef struct {

uint32 numCCMs;
uint32 addEntry;
uint32 addEntryUnprotected;
uint32 addEntryTime;
uint32 addEntryTotalTime;
uint32 removeEntry;
uint32 removeEntryTime;
uint32 removeEntryTotalTime;
uint32 addEntryMC;
uint32 addEntryNumberMC;
uint32 addEntryTimeMC;
uint32 addEntryTotalTimeMC;
uint32 removeEntry;
uint32 removeEntryNumberMC;
uint32 removeEntryTimeMC;
uint32 removeEntryTotalTimeMC;
uint32 getRoute;
uint32 getRouteMC;
uint32 getRouteBD;
uint32 setFlags;
uint32 getFlags;
uint32 isActive;
uint32 setBandwidth;
uint32 getBandwidth;
uint32 setAvailable;
uint32 getAvailable;
uint32 setTD;
uint32 getTD;
uint32 getIngressPort
uint32 getEgressPort;
uint32 getEgressPortW;
uint32 getEgressPortP;
uint32 getCCMEntry;
} ccmStats_t;
ccmStats_t *ccm_g_ccmStats;
class CCMgr {
public:
enum {

ccm_INVALID_CKT = 0xffffffff

};
CCMgr(uint32 size; uint32 type);
˜CCMgr();
// TBD
listenPDU();
processPDU();
constructPDU();
sendPDU();
monitorCCM();

private:

uint32 size;
uint32 type;
ccmStats_t stats;
uint32 *ccmLinkAlloc;
ccmPortEntry_t *ccmIngressPortMap;
ccmPortEntry_t *ccmEgressPortMap;
ccmPortEntry_t *ccmFirstStageElementMap;
ccmPortEntry_t *ccmSecondStageElementMap;
ccmPortEntry_t *ccmThirdStageElementMap;
ccmEntry_t *ccmTable;
int32 addEntry(cid_t& cid; uint32 flags; port_t ingressPort;
port_t egressPort);
int32 removeEntry(cid_t cid);
int32 addEntryMC(cid_t cid; uint32 number;
const port_t& egressPortsMC);
int32 removeEntryMC(cid_t cid; uint32 number;
const port_t& egressPortsMC);
int32 getRoute(cid_t cid);
int32 getRouteMC(cid_t cid; port_t egressPort);
int32 getRouteBD(cid_t cid);
int32 getRouteP(cid_t cid);
int32 setFlags(cid_t cid, uin32 flags);
int32 getFlags(cid_t cid, uin32& flags);
int32 isActive(cid_t, bool& status);
int32 setBandwidth(cid_t cid, bandwidth_t bandwidth);
int32 getBandwitdh(cid_t cid, bandwidth_t& bandwidth);
int32 setAvailable(cid_t cid, bandwidth_t bandwidth);
int32 getAvailable(cid_t cid, bandwidth_t& bandwidth);
int32 setTD(cid_t cid, td_t td);
int32 getTD(cid_t cid, td_t& td);
int32 getIngressPort(cid_t cid, port_t& port);
int32 getEgressPort(cid_t cid, port_t& port);
int32 getLink(cid_t cid, stage_t stage, link_t& link);
int32 getLinkW(cid_t cid, stage_t stage, link_t& link);
int32 getLinkP(cid_t cid, stage_t stage, link_t& link);
int32 getCCMEntry(cid_t cid, ccmEntry_t& entry);

};
enum {

ccm_NUM_PORT_FIELDS =
(sizeof(cktPortEntry_t)/sizeof(uint32)),
ccm_MAX_PORTS_64x64 = 32,
ccm_MAX_PORTS_128x128 = 64,
ccm_MAX_PORTS_256x256 = 128,
ccm_MAX_PORTS_512x512 = 256,

};

Following are examples of port mappings. In the example, the 64×64 ports are randomly assigned and 512×512 port assignments are linear.

// Port map 64x64
const uint32
ccmIngressPortMap64x64[ccm_MAX_PORTS_64x64*ccm_NUM_PORT_FIELDS] =

{// chassis, slot, port, wave, chan
// c, s, p, w, c,

0, 6, 0, 0, 0,
0, 6, 1, 0, 0,
0, 6, 2, 0, 0,
0, 6, 7, 0, 0,
0, 6, 6, 0, 0,
0, 6, 4, 0, 0,
0, 6, 5, 0, 0,
0, 6, 3, 0, 0,
0, 7, 0, 0, 0,
...,
0, 15, 7, 0, 0,

};
const uint32
ccmEngressPortMap64x64[ccm_MAX_PORTS_64x64*ccm_NUM_PORT_FIELDS] =

{// chassis, slot, port, wave, chan
// c, s, p, w, c,

0, 6, 8, 0, 0,
0, 6, 9, 0, 0,
0, 6, 10, 0, 0,
0, 6, 15, 0, 0,
0, 6, 14, 0, 0,
0, 6, 12, 0, 0,
0, 6, 13, 0, 0,
0, 6, 11, 0, 0,
0, 7, 8, 0, 0,
...,
0, 15, 15, 0, 0,

};
// Port map 128x128
const uint32

ccmIngressPortMap512x512[ccm_MAX_PORTS_128x128*ccm_NUM_PORT_FIELDS] =

{// chassis, slot, port, wave, chan,
// c, s, p, w, c,
...,
}

const uint32

ccmEgressPortMap512x512[ccm_MAX_PORTS_128x128*ccm_NUM_PORT_FIELDS]=

{// chassis, slot, port, wave, chan,
// c, s, p, w, c,
...,
}

// Port map 256x256
const uint32

ccmIngressPortMap256x256[ccm_MAX_PORTS_256x256*ccm_NUM_PORT_FIELDS] =

{// chassis, slot, port, wave, chan,
// c, s, p, w, c,
...,
};

const uint32

ccmEgressPortMap256x256[ccm_MAX_PORTS_256x256*ccm_NUM_PORT_FIELDS] =

{// chassis, slot, port, wave, chan,
// c, s, p, w, c,
...,
};

// Port map 512x512
const uint32

ccmIngressPortMap512x512[ccm_MAX_PORTS_512x512*ccm_NUM_PORT_FIELDS] =

{// chassis, slot, port, wave, chan,
// c, s, p, w, c,

2, 3, 0, 0, 0,
2, 3, 1, 0, 0,
2, 3, 2, 0, 0,
...,
2, 3, 8, 0, 0,
2, 3, 15, 0, 0,
...,
3, 4, 1, 0, 0,
...,
3, 4, 15, 0, 0,
...,
4, 3, 0, 0, 0,
...,
5, 17, 15, 0, 0

};

const uint32

ccmEgressPortMap512x512[ccm_MAX_PORTS_512x512*ccm_NUM_PORT_FIELDS] =

{// chassis, slot, port, wave, chan,
// c, s, p, w, c,

2, 3, 0, 0, 0,
2, 3, 1, 0, 0,
2, 3, 2, 0, 0,
...,
2, 3, 8, 0, 0,
2, 3, 15, 0, 0,
...,
3, 4, 1, 0, 0,
...,
3, 4, 15, 0, 0,
...,
4, 3, 0, 0, 0,
...,
5, 17, 15, 0, 0

};

enum {

ccm_NUM_ELEMENT_FIELDS =

(sizeof(cktElementEntry_t)/sizeof(uint32)),

ccm_MAX_ELEMENTS_FIRST_64x64 = 8;
ccm_MAX_ELEMENTS_FIRST_128x128 = 16;
ccm_MAX_ELEMENTS_FIRST_256x256 = 32;
ccm_MAX_ELEMENTS_FIRST_512x512 = 64;
ccm_MAX_ELEMENTS_SECOND_64x64 = 1;
ccm_MAX_ELEMENTS_SECOND_128x128 = 2;
ccm_MAX_ELEMENTS_SECOND_256x256 = 4;
ccm_MAX_ELEMENTS_SECOND_512x512 = 8;
ccm_MAX_ELEMENTS_THIRD_64x64 = 8;
ccm_MAX_ELEMENTS_THIRD_128x128 = 16;
ccm_MAX_ELEMENTS_THIRD_256x256 = 32;
ccm_MAX_ELEMENTS_THIRD_512x512 = 64;

};
// Element Map 64x64
const uint32

ccmFirstStageElementMap64x64[ccm_MAX_ELEMENTS_FIRST_64x64*ccm_NUM_ELEMENT_FIELDS] =

{// chassis, slot,
// c, s,

0, 6,
0, 7,
0, 8,
0, 9,
0, 12,
0, 13,
0, 14,
0, 15,

};

const uint32

ccmSecondStageElementMap64x64[ccm_MAX_ELEMENTS_SECOND_64x64*ccm_NUM_ELEMENT_FIELDS] =

{// chassis, slot,
// c, s,

0, 10,

}

const uint32

ccmThirdStageElementMap64x64[ccm_MAX_ELEMENTS_THIRD_64x64*ccm_NUM_ELEMENT_FIELDS] =

{// chassis, slot,
// c, s,

0, 6,
0, 7,
0, 8,
0, 9,
0, 12,
0, 13,
0, 14,
0, 15,

};

Circuit Identifier Manager

A Circuit Identifier Manager (CIDMgr) object maintains circuit identifiers (cids) in the switch system. CIDs are allocated by finding the first available cid in the cid table. The CIDMgr maintains a table in which each bit represents the allocation of that cid. There is a current pointer that points to the last allocated cid. When a request is made for allocating a new cid, the CIDMgr object indexes into the binary array until it finds an unallocated cid. The CIDMgr object marks the cid as allocated, and returns the allocated cid to the caller. When a cid is freed, the corresponding allocation bit is set to indicate that the cid is now available. When the current pointer reaches the end of the cid array, the pointer wraps back to the first element in the array.

Note the above algorithm could also be used to find the lowest cid available. A problem with using the lowest cid includes that there is a high possibility that the reused cid was recently freed and that the cid might still have some dangling references due to possible network timeouts or bugs. Therefore, other search algorithms may be used to find an available cid as discussed above.

The class API for the CIDMgr object may provide the following public member functions:

1. CIDMgr(unit32): The constructor will allocate memory for the CID table from heap. If the function fails to allocate for some reason we will panic.

2. ˜CIDMgr( ): The destructor will free the memory allocated for the CID table, clear the CID Table pointer.

3. alloc( ): This function returns the next available CID. Or the function the function fails the function returns an invalid CID.

4. free(cid_t): This function will free the specified CID. If the function is outside the valid range the function returns invalid CID. Otherwise the function returns the specified CID.

5. size( ): This function returns the size of the CID Table allocated.

6. mark(cid_t): This function will mark a CID to be allocated. If the circuit is outside the valid range the function returns invalid CID. Otherwise, the function returns the specified CID.

typedef uint32 cid_t;
class CIDMgr {

public:

enum {

cid_INVALID_CID = 0xffffffff

};
CIDMgr(uint32 size);
˜CIDMgr();
cid_t alloc();
cid_t free(cid_t cid);
uint32 size();
int32 mark(cid_t cid);

private:

uint32 size;
cid_t currentCID;
cid_t *cidTABLE;

}

Circuit Manager

Circuit Manager (CktMgr) object represents each physical cross connect switch stage. The CktMgr object maintains a circuit table (cktTable[cid]) that keeps track of the current state of the cross connect. A table entry of the circuit table tracks all unicast and multicast circuit entries created in the switch element. Based on the card type, there can be one or more switch elements present in the card. A per card type table may be maintained that specifies the specific card types' switch stage configuration. The switch stage configuration may specify a number of elements and each switch element.

The class API may provide the following public and private member functions:

1. CktMgr(size, type): The constructor allocates memory for CktTable from heap.for specified size. Based on the card type, the CktMgr function then creates and initializes appropriate pointers so that the cross connect can be configured appropriately. If the CktMgr function fails to allocate memory, the object enters a panic state.

2. ˜CktMgr( ): The destructor will free the memory allocated for the Ckt table from heap, and clears the pointer to the table.

3. addentry(cid, ingressPort, egressPortW, egressPortP): This function creates a unidirectional circuit entry indexed at cid with the specified ingress and egress ports.

If egressPortP is invalid port type (Oxffffffff) then it is considered an unprotected request. If the circuit is already active, an error is returned. A circuit must be first removed before the circuit can be reset.

4. removeEntry(cid): This function removes the circuit entry at cid index. If the circuit was inactive, an error is returned.

5. addMCEntry(cid, number, egressPortsMC): This function creates a unidirectional multicast circuit entry at cid index. The number of multicast egress ports being passed is specified to this function. One or more egress ports can be requested at the same invocation. If there is an error adding one or more egress ports, an error status may be returned. Adding a multicast circuit for an inactive circuit also results in an error.

6. removeMCEntry(cid, number, egressPortsMC): This function removes the specified multicast egress ports from the multicast circuit entry at cid. The number of multicast egress ports being passed is specified to this function. One or more egress ports can be requested at the same invocation. If there is an error removing one or more egress ports, an error status is returned. Removing a multicast circuit for an inactive circuit also results in an error.

7. switchPort(cid): This function switches the input of the cross connect from the working port to protect port. According to one embodiment of the invention, this switching is performed only on the egress stage. Ingress stage is dual cast to redundant paths, so no switchover is necessary. If the cid is invalid, this function returns an error status.

8. getlngressport(cid, port): This function passes back the ingress port for cid. If the circuit is inactive, the function returns an error status. It the cid is invalid, the function returns an error status.

9. getEgressPort(cid, port): This function passes back the current active egress port for a particular cid. If the circuit is inactive, the function returns an error status. If the cid is invalid, the function returns an error status.

10. getPortW(cid, port): This function passes back the working port for a particular cid. If the circuit is inactive, the function returns an error status. If the cid is invalid, the function returns an error status.

11. getPortP(cid, port): This function passes back the protect port for a particular cid. If the circuit is inactive, the function returns an error status. If the cid is invalid, the function also returns an error status.

12. getCktEntry(cid, entry): This function passes back the circuit entry for a particular cid. If the circuit is inactive, the function returns an error status. If the cid is invalid, the function returns an error status.

// Circuit Entry
typedef struct {

bandwidth_t bandwidth;
bandwidth_t available;
port_t ingressPort;
port_t egressPort;
port_t PortW;
port_t PortP;
cktMCEntry_t *cktMCEntry;

} cktEntry_t;
// Multicast Circuit Entry
typedef struct {

uint32 number; // number of MC entries
uint32 size; // size of allocated cidMCTable
port_t *cidMCTable;

} cktMCEntry_t;
// Circuit Link Entry
typedef struct {

element_t element;
uint32 address;

} cktPortEntry_t;
// Circuit Link Entry
typedef struct {

element_t element;
uint32 address;

} cktLinkEntry_t;
// Circuit Statistics
typedef struct {

uint32 numCkts;
uin32 switchovers;
uint32 addEntry;
uint32 addEntryUnprotected;
uint32 addEntryTime;
uint32 addEntryTotalTime;
uint32 removeEntry;
uint32 removeEntryTime;
uint32 removeEntryTotalTime;
uint32 addEntryMC;
uint32 addEntryNumberMC;
uint32 addEntryTimeMC;
uint32 addEntryTotalTimeMC;
uint32 removeEntryMC;
uint32 removeEntryNumberMC;
uint32 removeEntryTimeMC;
uint32 removeEntryTotalTimeMC;
uint32 getIngressPort
uint32 getEgressPort;
uint32 getPortW;
uint32 getPortP;
uint32 getCktEntry;

} cktStats_t;
enum {

ckt_MAX_ELEMENTS = 4;

}
// Switch stages for card type
cktStage[/*cardType*/][1+ckt_MAX_ELEMENTS] =

| | | |
|---|---|---|
| { | // Number of | elements, element type 1, element type 2, |

| | |
|---|---|
| // | element type 3, element type 4 |

...
{ 2, vsc_TYPE_VSC835, vsc_TYPE_VSC835, vsc_TYPE_INVALID,

vsc_TYPE_INVALID}, // PIC 2, 32x32

{ 1, vsc_TYPE_VSC836, vsc_TYPE_INVALID, vsc_TYPE_INVALID,

vsc_TYPE_INVALID}, // SSC 1, 64x64

...

}

cktStats_t *ckt_g_cktStats;
class CktMgr {
public:

enum {

ckt_INVALID_CKT = 0xffffffff

};
CktMgr(uint32 size; uint32 type);
˜CktMgr();
// TBD
listenPDU();
processPDU();
constructPDU();
sendPDU();
monitorCkt();

private:

```
uint32 size;
uint32 type;
cktStats_t stats;
cktPortEntry_t *cktFirstStagePortMap;
cktPortEntry_t *cktThirdStagePortMap;
cktLinkEntry_t *cktSecondStageFromFirstLinkMap;
cktLinkEntry_t *cktSecondStageFromThirdLinkMap;
cktEntry_t *cktTable;
int32 addEntry(cid_t cid; port_t ingressPort; port_t egressPortW;
    port_t egressPortP);
int32 removeEntry(cid_t cid);
int32 addEntryMC(cid_t cid; uint32 number;
      const port_t& egressPortsMC);
int32 removeEntryMC(cid_t cid; uint32 number;
      const port_t& egressPortsMC);
int32 switchPort(cid_t cid);
int32 getIngressPort(cid_t cid, port_t& port);
int32 getEgressPort(cid_t cid, port_t& port);
int32 getPortW(cid_t cid, port_t& port);
int32 getPortP(cid_t cid, port_t& port);
int32 getCktEntry(cid_t cid, cktEntry_t& entry);
```

}
enum {

ckt_NUM_PORT_FIELDS = (sizeof(cktPortEntry_t)/sizeof(uint32)),
ckt_MAX_PORTS_64x64 = 8,
ckt_MAX_PORTS_128x128 = 8,
ckt_MAX_PORTS_256x256 = 8,
ckt_MAX_PORTS_512x512 = 8,

};
// Stage port map 64x64
const unit32

cktFirstStagePortMap64x64[ckt_MAX_LINKS_FIRST_64x64*ckt_NUM_PORT_FIELDS] =

{// element, address
// e, a,

0, 0,
0, 1,
0, 2,
0, 7,
0, 5,
0, 3,
0, 4,
0, 6,

};
const unit32

cktThirdStagePortMap64x64[ckt_MAX_LINKS_FIRST_64x64*ckt_NUM_PORT_FIELDS] =

{// element, address
// e, a,

1, 0,
1, 1,
1, 2,
1, 7,
1, 5,
1, 3,
1, 4,
1, 6,

};
enum {

ccm_NUM_LINK_FIELDS = (sizeof(cktLinkEntry_t)/sizeof(uint32)),
ckt_MAX_LINKS_FIRST_64x64 = 16,
ckt_MAX_LINKS_FIRST_128x128 = 16,
ckt_MAX_LINKS_FIRST_256x256 = 16,
ckt_MAX_LINKS_FIRST_512x512 = 16,
ckt_MAX_LINKS_SECOND_64x64 = 64,
ckt_MAX_LINKS_SECOND_128x128 = 128,
ckt_MAX_LINKS_SECOND_256x256 = 256,
ckt_MAX_LINKS_SECOND_512x512 = 512,
ckt_MAX_LINKS_THIRD_64x64 = 16,
ckt_MAX_LINKS_THIRD_128x128 = 16,
ckt_MAX_LINKS_THIRD_256x256 = 16,
ckt_MAX_LINKS_THIRD_512x512 = 16,

};
// Stage link map 64x64
const unit32

cktFirstStageLinkMap64x64[ckt_MAX_LINKS_FIRST_64x64*ccm_NUM_LINK_FIELDS] =

{// element, address
// e, a,

0, 0,
0, 1,
0, 3,
0, 5,
0, 7,
0, 9,
0, 11,
0, 13,
0, 15,
0, 2,
0, 4,
0, 6,
0, 8,
0, 10,
0, 12,
0, 14,

};

const unit32

cktSecondStageLinkMap64x64[ckt_MAK_LINKS_SECOND_64x64*ccm_NUM_LINK_FIELDS] =

{// element, address
// e, a,

0, 0,
0, 1,
0, 3,
...,
0, 62,
...,
0, 63,

};

const unit32

cktThirdStageLinkMap64x64[ckt_MAX_LINKS_THIRD_64x64*ccm_NUM_LINK_FIELDS] =

{// element, address
// e, a,

1, 0,
1, 1,
1, 3,
1, 5,
1, 7,
1, 9,
1, 11,
1, 13,
1, 15,
1, 2,
1, 4,
1, 6,
1, 8,
1, 10,
1, 12,
1, 14,

};

// Stage link map 128x128
const unit32

cktFirstStageLinkMap128x128[ckt_MAX_LINKS_FIRST_128x128*ccm_NUM_LINK_FIELDS*ccm_NUM_LINK_FIELDS] =

{// element, address
// e, a,

0, 0,
...,

}

const unit32

cktSecondStageLinkMap128x128[ckt_MAK_LINKS_SECOND_128x128*ccm_NUM_LINK_FIELDS] =

{// element, address
// e, a,

0, 0,
...,

}

const unit32

cktThirdStageLinkMap128x128[ckt_MAX_LINKS_THIRD_128x128*ccm_NUM_LINK_FIELDS] =

{// element, address
// e, a,

1, 0,
...,

}

// Stage link map 256x256
const unit32

cktFirstStageLinkMap256x256[ckt_MAX_LINKS_FIRST_256x256*ccm_NUM_LINK_FIELDS] =

{// element, address
// e, a,

0, 0,
...,

}

const unit32

cktSecondStageLinkMap256x256[ckt_MAK_LINKS_SECOND_256x256*ccm_NUM_LINK_FIELDS] =

{// element, address
// e, a,

0, 0,
...,

}

const unit32

cktThirdStageLinkMap256x256[ckt_MAX_LINKS_THIRD_256x256*ccm_NUM_LINK_FIELDS] =

{// element, address
// e, a,

1, 0,
...,

}

// Stage link map 512x512
unit32

cktFirstStageLinkMap512x512[ckt_MAX_LINKS_FIRST_512x512*ccm_NUM_LINK_FIELDS] =

{// element, address
// e, a,

0, 0,
...,

}

const unit32

cktSecondStageLinkMap512x512[ckt_MAK_LINKS_SECOND_512x512*ccm_NUM_LINK_FIELDS] =

{// element, address
// e, a,

0, 0,
...,

}

const unit32

cktThirdStageLinkMap512x512[ckt_MAX_LINKS_THIRD_512x512*ccm_NUM_LINK_FIELDS] =

{// element, address
// e, a,

1, 0,
...,

Crosspoint Switch Driver

As discussed above, PICs 907, 910 and SSCs 908, 909 include drivers which access respective framer and cross connect modules. A base class for a cross connect type device may be created. A derived class may be created for each of the independent driver types for each of the different types of framer and cross connect modules that may be present on PICs 907, 910 and SSCs 908, 909. Each element type is represented by a table that maintains the corresponding switch element types' dimensions.

The base class API may provide the following public member functions:

1. VSCSwitch(element, baseAddress, type): The constructor is invoked by the derived class and maintain the common information across different specific cross connect objects. When a particular card boots, based on the card type the appropriate cross connect switch element type is created. For example, on SSCs 908, 909, appropriate number of cross connect switch elements is initialized. On PICs 907, 910, appropriate number of cross connect switch elements is initialized.

2. ˜VSCSwitch( ): The destructor.

3. setConnect(input, output): This function connects the output port to the input port for the specified cross connect switch element. In case of an invalid request the function returns with an appropriate error status.

4. getConnect(input, output): This function passes back the input port that is configured to connect to the specified output port for the specified element. In case of an invalid request, the function returns with an appropriate error status.

5. monitorLOA(nth32 Bits, status): This function passes back the current LOA status of the Nth 32 Bits/Ports for the specified element. In case of an invalid request, the function returns with an appropriate error.

6. monitorINT(nth32 Bits, status): This function passes back the current interrupt status of the Nth 32 Bits/Ports for the specified element. In case of an invalid request, the function returns with an appropriate error.

7. getSize( ): This function returns the size of the elements cross connect.

// Switch element types dimensions
vscElement[/*elementType*/ vsc_TYPE_MAX] =

{ // input size, output size

{ 0, 0 },// invalid type
{ 34, 34 },// vsc835 34x34
{ 64, 65 },// vsc836 64x65

};

class VSCSwitch {

public:

enum {

vsc_INVALID_PORT = 0xffffffff;
vsc_TYPE_INVALID = 0;
vsc_TYPE_VSC835 = 1;
vsc_TYPE_VSC836 = 2;
vsc_TYPE_MAX = 3;

};
VSCSwitch(uint32 element; uint32 baseAddress; uint32 type);
˜VSCSwitch();
virtual int32 setConnect(port_t input; port_t output);
virtual int32 getConnect(port_t *input; port_t output);
virtual int32 monitorLOA(uint32 nth32Bits; uint32 status);
virtual int32 monitorINT(uint32 status);
uint32 getSize();
private:

uint32 element;
uint32 baseAddress;
uint32 type;
uint32 size;

}

Interface Object

The Interface object described above is used to perform functions related to interfaces of PICs 907, 910 and SSCs 908, 909. If the interface is a SONET interface, this object may support ANSI T.1231 SONET functionality. The Interface object also provides a mechanism (via virtual member function or callback) which invokes a function in a CktMgr object when APS switchover criteria has been met for the port object either representing on the PIC cards the framer or crosspoint switch module. On the SSC, the port object represents its respective crosspoint switch module. When an error is detected by the interface object, the object triggers the CktMgr object to switchover to the protect/redundant receive link in the cross connect.

It should be appreciated that other methods and other data structures may be used to implement the object-oriented software objects described above. Also, it should be understood that functional programming may be used.

While various embodiments of the present invention have been described above, it should be understood that they have been presented by way of example only, and not limitation. Thus, the breadth and scope of the present invention are not limited by any of the above exemplary embodiments, but are defined only in accordance with the following claims and their equivalents.

1. A method for determining a connection in a network system, the method comprising:
defining a logical abstraction having a plurality of switch stages, each stage having at least one port;
defining a physical abstraction having an associated plurality of components wherein at least one component has a physical port; and
mapping the at least one port in the logical abstraction to the physical port of the component associated with the physical abstraction.

2. The method according to claim 1, further comprising:
determining a logical path through the plurality of switch stages defined by the logical abstraction.

3. The method according to claim 1, wherein each of the plurality of connections between each stages are represented by a level of a logical representation, the logical representation holding state information indicating an availability of said connections, the plurality of switch stages having a plurality of connection between stages, and the method further comprises setting up a circuit between an ingress and egress port of the network system.

4. The method according to claim 3, wherein the setting up operation comprises:
processing a request to establish the circuit;
determining an egress port of a third switch stage of the plurality of switch stages in the logical abstraction;
locating, within the logical representation, an available connection between the third switch stage and a second switch stage of the plurality of switch stages; and
locating, within the tree representation, an available connection between the second stage and a first switch stage in which the ingress port resides.

5. The method according to claim 4, wherein if it is determined that an available connection does not exist between the ingress and egress ports, the method further comprises searching another second switch stage for an available connection.

6. The method according to claim 4, wherein the location operations include identifying a first found connection.

7. The method according to claim 4, wherein the location operations include identifying a connection using a round robin search.

8. The method according to claim 4, wherein the location operations include identifying a connection using a randomization process.

9. The method according to claim 1, wherein the logical abstraction includes logical switch elements having logical ports identified by a logical port number, and wherein the mapping operation further comprises mapping a logical port number to the physical port of the component.

10. The method according to claim 1, further comprising mapping based on a combination of chassis, slot, port, wave, and channel.

11. The method according to claim 1, wherein the logical abstraction is modeled as a generic Clos switch architecture.

12. The method according to claim 1, wherein the physical abstraction is modeled as a hardware-specific Clos switch architecture.

13. The method according to claim 4, wherein the logical representation is stored in at least one table in memory of the switch.

14. The method according to claim 4, wherein the logical representation is a tree-like data structure stored in a memory associated with the switch.

15. The method according to claim 4, further comprising determining whether an available link has sufficient resources.

16. The method according to claim 3, wherein the setting up operation includes setting up a connection in a direction from the ingress port to the egress port.

17. The method according to claim 3, wherein the setting up operation includes setting up a connection in a direction from the egress port to the ingress port.

18. The method according to claim 1, wherein the plurality of switch stages includes at least three switch stages.

19. A computer-readable medium, when executed in a network communication system, performs a method for determining a connection in a network system, the method comprising:
defining a logical abstraction having a plurality of switch stages, each stage having at least one port;
defining a physical abstraction having an associated plurality of components wherein at least one component has a physical port; and
mapping the at least one port in the logical abstraction to the physical port of the component associated with the physical abstraction.

20. The computer-readable medium according to claim 19, further comprising:
determining a logical path through the plurality of switch stages defined by the logical abstraction.

21. The computer-readable medium according to claim 19, wherein each of the plurality of connections between each stages are represented by a level of a logical representation, the logical representation holding state information indicating an availability of said connections, the plurality of switch stages having a plurality of connection between stages, and the method further comprises setting up a circuit between an ingress and egress port of the network system.

22. The computer-readable medium according to claim 21, wherein the setting up operation comprises:
processing a request to establish the circuit;
determining an egress port of a first switch stage of the plurality of switch stages in the logical abstraction;
locating, within the logical representation, an available connection between the first switch stage and a second switch stage of the plurality of switch stages; and
locating, within the logical representation, an available connection between the second stage and a third switch stage in which the ingress port resides.

23. The computer-readable medium according to claim 22, wherein if it is determined that an available connection does not exist between the ingress and egress ports, the method further comprises searching another second switch stage for an available connection.

24. The computer-readable medium according to claim 22, wherein the location operations include identifying a first found connection.

25. The computer-readable medium according to claim 22, wherein the location operations include identifying a connection using a round robin search.

26. The computer-readable medium according to claim 22, wherein the location operations include identifying a connection using a randomization process.

27. The computer-readable medium according to claim 19, wherein the logical abstraction includes logical switch elements having logical ports identified by a logical port number, and wherein the mapping operation further comprises mapping a logical port number to the physical port of the component.

28. The computer-readable medium according to claim 19, further comprising mapping based on a combination of chassis, slot, port, wave, and channel.

29. The computer-readable medium according to claim 19, wherein the logical abstraction is modeled as a generic Clos switch architecture.

30. The computer-readable medium according to claim 19, wherein the physical abstraction is modeled as a hardware-specific Clos switch architecture.

31. The computer-readable medium according to claim 22, wherein the logical representation is stored in at least one table in memory of the switch.

32. The computer-readable medium according to claim 22, further comprising determining whether an available link has sufficient resources.

33. The computer-readable medium according to claim 21, wherein the setting up operation includes setting up a connection in a direction from the ingress port to the egress port.

34. The computer-readable medium according to claim 21, wherein the setting up operation includes setting up a connection in a direction from the egress port to the ingress port.

35. The computer-readable medium according to claim 19, wherein the plurality of switch stages includes at least three switch stages.

36. The computer-readable medium according to claim 22, wherein the logical representation is a tree-like data structure stored in a memory associated with the switch.
